(19) United States
(12) Patent Application Publication
(10) Pub. No.: US 2005/0025176 A1
(43) Pub. Date: Feb. 3, 2005

(54) Medium access control in wireless local area network

(76) Inventors: Seong-Yun Ko, Seoul (KR); Seong-Joon Jeon, Yongin-si (KR); Soung-Kwan Kim, Suwon-si (KR); Myeon-Kee Youn, Nundong-gu (KR); Joo-Yong Park, Bundang-gu (KR)

Correspondence Address: Robert E. Bushnell;Suite 300, 1522 K Street, N.W., Washington, DC, 20005-1202, US

(21) Appl. No.: 10/891,329

(22) Filed: Jul. 15, 2004

(30) Foreign Application Priority Data
Jul. 29, 2003 (KR) 2003-52455

(51) Int. Cl. H04B 7/212; H04L 12/413

(52) U.S. Cl. 370/448

(57) ABSTRACT

A medium access control method and apparatus and program storage device in a CSMA/CA (Carrier Sense Multiple Access with Collision Avoidance) based wireless LAN (Local Area Network) classifies stations in a CSMA/CA based wireless LAN system into a number of groups according to a transmission priority to assign a different DIFS (Distributed Coordination Function InterFrame Space) to each group. Different and fixed back-off times are assigned to stations that belong to the same priority group according to the transmission priority, and the back-off time is reset to the back-off time that each station has been assigned for every re-transmission contention, to guarantee a transmission opportunity to the station with the higher transmission priority in the same priority group, and to guarantee a transmission opportunity to the station with the higher transmission priority irrespective of the number of stations that wish to make a transmission, and to reduce a chance of collision so as not to degrade a throughput since the waiting time of each station is different.

CLAIM OF PRIORITY AND CROSS-REFERENCE TO RELATED APPLICATIONS

This application makes reference to, incorporates the same herein, and claims all benefits accruing under 35 U.S.C. § 119 from an application for METHOD FOR MEDIUM ACCESS CONTROL IN WIRELESS LOCAL AREA NETWORK SYSTEM BASED ON CARRIER SENSE MULTIPLE ACCESS WITH COLLISION AVOIDANCE AND APPARATUS THEREOF earlier filed in the Korean Intellectual Property Office on 29 Jul. 2003 and there duly assigned Serial No. 2003-52455. Furthermore, the present application is related to co-pending U.S. application Ser. No. (to be determined), entitled METHOD FOR MEDIUM ACCESS CONTROL IN WIRELESS LOCAL AREA NETWORK SYSTEM BASED ON CARRIER SENSE MULTIPLE ACCESS WITH COLLISION AVOIDANCE, AND STATION FOR PERFORMING THE SAME, based upon a Korean Patent Application Serial No. 2003-52456 filed in the Korean Intellectual Property Office on 29 Jul. 2003, and filed in the U.S. Patent & Trademark Office concurrently with the present application.

### BACKGROUND OF THE INVENTION

1. Field of the Invention

The present invention relates to a medium access control in a wireless LAN (Local Area Network) based on CSMA/CA (Carrier Sense Multiple Access with Collision Avoidance). More particularly, the present invention relates to enabling a number of stations to have access to a media through a transmission contention in order to occupy the media in a wireless LAN based on CSMA/CA.

2. Description of the Related Art

A wireless LAN, as a communication network capable of transmitting and receiving data, has an increased number of users every year due to various merits, such as portability, capability to readily be mounted, etc. So far, information capable of transceiving through the wireless LAN has mostly been for documents, for use in the Internet, and the like. However, recently, techniques for providing a voice call service, a multilateral teleconference service, a real-time image transmission service, etc., all of which require real time characteristics, are being actively researched. Accordingly, recently, a wireless LAN telephone capable of sending and receiving a telephone call by accessing the wireless LAN has been commercialized.

In order to provide various application services which require such real-time characteristics, the wireless LAN must guarantee QoS (Quality of Service) to stations/users who use such services. Additionally, since each station connected to the wireless LAN has a different level of service, a function that can provide an optimal service to the different stations must also be implemented.

Wireless LAN specifications that are widely used nowadays have a function capable of ensuring QoS, CoS (Class of Service), or have a procedure to supplement the function. The wireless LAN specification of the IEEE (Institute of Electrical and Electronic Engineers) that is widely used including North America and the Republic of Korea, also supports PCF (Point Coordination Function), which is a function for media access control by a polling scheme, as an option in order to make a real-time information transmission possible.

The wireless LAN standard of the IEEE follows “Standard for Information technology-Telecommunications and information exchange between systems-Local and metropolitan area networks-Specific requirements-Part 11: Wireless LAN Medium Access Control (MAC) and Physical Layer (PHY) Specifications” published in 1999.

Hereinafter, the wireless LAN standard of the IEEE mentioned above will be referred to as the IEEE 802.11 standard. Specifications on physical Layers and Medium Access Control (MAC) for the wireless LAN are defined in the IEEE 802.11 standard.

The MAC layer allows a capacity of a medium to be effectively utilized by defining orders and rules that should be followed when a station or apparatus which uses a shared medium uses/accesses the medium. IEEE 802.11 defines two types of access control methods, that is, Distributed Coordination Function (DCF) and Point Coordination Function (PCF).

The following patents each discloses features in common with the present invention but do not teach or suggest the inventive features specifically recited in the present application: U.S. patent application Ser. No. 2004/0028072 to Moutarlier, entitled COMPUTER IMPLEMENTED METHOD FOR ASSIGNING A BACK-OFF INTERVAL TO AN INTERMEDIARY NETWORK ACCESS DEVICE, published on Feb. 12, 2004; U.S. patent application Ser. No. 2004/0004973 to Lee, entitled METHOD FOR PERFORMING CONTENTION-BASED ACCESS FOR REAL-TIME APPLICATION AND MEDIUM ACCESS CONTROL HIERARCHY MODULE, published on Jan. 8, 2004; U.S. patent application Ser. No. 2003/0161340 to Sherman, entitled METHOD AND SYSTEM FOR OPTIMALLY SERVING STATIONS ON WIRELESS LANS USING A CONTROLLED CONTENTION/RESOURCE RESERVATION PROTOCOL OF THE IEEE 802.11E STANDARD, published on Aug. 28, 2003; U.S. patent application Ser. No. 2002/0188750 to Li, entitled NEAR OPTIMAL FAIRNESS BACK OFF METHODS AND SYSTEMS, published on Dec. 12, 2002; U.S. patent Ser. No. 6,671,284 to Yonge III et al., entitled FRAME CONTROL FOR EFFICIENT MEDIA ACCESS, published on Dec. 30, 2003; and U.S. patent Ser. No. 5,940,399 to Weizman, entitled METHODS OF COLLISION CONTROL IN CSMA LOCAL AREA NETWORK published on Aug. 17, 1999.

### SUMMARY OF THE INVENTION

It is an object of the present invention to provide medium access control in a CSMA/CA based wireless LAN that enables each station to occupy the medium according to an assigned transmission priority when a number of stations in the CSMA/CA based wireless LAN system perform a transmission contention in order to occupy the medium.

In order to accomplish this object, according to an aspect of the present invention, there is provided a medium access control method of an AP(Access Point) in a CSMA/CA based wireless LAN comprising the steps of: defining a plurality of groups to which a priority is given, and assigning different DIFSs (DCF InterFrame Spaces) and maximum back-off times to each group according to the priority such that a sum of the DIFS and the maximum back-off time of a group to which an arbitrary priority is given is smaller than the sum of the DIFS and the maximum back-off time of the next lower priority group; organizing stations connected to the wireless LAN into the defined group according to a transmission priority; assigning different and fixed back-off times to each station organized into an arbitrary group below a range of the maximum back-off time organized to the group according to the transmission priority among the stations assigned to the group such that the sum of the DIFS and the maximum back-off time of the group to which the arbitrary priority is given is smaller than the sum of the DIFS and the maximum back-off time of a next lower priority group; and transmitting the assigned DIFS and back-off time each station in order for each station to reset its back-off time to the fixed back-off time in every transmission contention by the DIFS assigned to the group into which the station is organized and the back-off time assigned to the station in the group, and to perform the medium access based on the CSMA/CA.

Here, it is preferable to assign different DIFSs and maximum back-off times such that the sum of the DIFS and the maximum back-off time of the group to which the arbitrary priority is given is smaller than the DIFS of the next lower priority group.

In order to accomplish this object, according to another aspect of the present invention, there is provided an AP in a CSMA/CA based wireless LAN comprising: a memory for storing a program; and a processor connected to the memory for executing the program, wherein with the program, the processor performs the steps of: defining a plurality of groups to which a priority is given, and assigning different DIFSs and maximum back-off times to each group according to the priority such that a sum of the DIFS and the maximum back-off time of a group to which an arbitrary priority is given is smaller than the DIFS of the next lower priority group; organizing stations connected to the wireless LAN into the defined group according to a transmission priority; assigning different and fixed back-offtimes to each station organized into an arbitrary group below a range of the maximum back-off time assigned to the group according to the transmission priority among the stations organized into the group; and transmitting the assigned DIFS and back-off time to each station in order for each station to perform the CSMA/CA based medium access by the DIFS assigned to the group into which it is organized and the back-off time assigned to itself in the group.

According to another aspect of the present invention, a medium access method of a wireless LAN station in a CSMA/CA based wireless LAN comprises: requesting a register of an AP in the wireless LAN, the AP classifying each station into a plurality of priority groups according to a transmission priority to assign different DIFSs to each priority group, and the AP assigning different and fixed back-off times according to the transmission priority in the same group and setting the DIFS and the back-off time of each station such that a sum of the DIFS and the back-off time has a fixed difference according to the transmission priority of each station; receiving and storing the DIFS and the back-offtime set into each station from the AP; attempting to make a contention for medium access by priority with the DIFS and the back-off time set into each station when the medium is be accessed for a data transmission; and resetting its back-off timer to the fixed back-off time to attempt to make a re-contention for medium access when the station fails in the contention for medium access.

According to yet another aspect of the present invention, a medium access control method in a CSMA/CA based wireless LAN system comprises: defining a plurality of groups to which a priority is given in an AP and assigning different DIFSs and maximum back-off times to each group according to the priority such that the sum of the DIFS and the maximum back-offtime of a group to which an arbitrary priority is given is smaller than the DIFS of the next lower priority group; organizing stations connected to the wireless LAN into the defined group according to a transmission priority in the AP; assigning different and fixed back-off times to each station organized into an arbitrary group below the range of the maximum back-off time assigned to the group according to the transmission priority among stations organized into the group in the AP; attempting to make a contention for medium access at each station by priority with the DIFS and the back-off time organized into itself when the station accesses the medium for data transmission; each station resetting its own back-off time to the fixed back-off time and attempting to make a re-contention for medium access when the station fails in the contention for medium access.

According to still yet another aspect of the present invention, a wireless LAN station in a CSMA/CA based wireless LAN comprises: a memory adapted to store a program; and a processor connected to the memory and adapted to execute the program, wherein, in accordance with the program, the processor: requests a register of an AP in the wireless LAN, the AP classifying each station into a plurality of priority groups according to a transmission priority to assign different DIFSs to each priority group, and the AP assigning different and fixed back-off times according to the transmission priority in the same group and setting the DIFS and the back-off time of each station such that a sum of the DIFS and the back-off time has a fixed difference according to the transmission priority of each station; receives and stores the DIFS and the back-off time set into the station from the AP; attempts to make a contention for medium access by priority with the DIFS and the back-off time set into the station when the station should have access to the medium for data transmission; and resets its back-off timer to the fixed back-off time to attempt to make a re-contention for medium access when the station fails in the contention for medium access.

Lastly, according to further aspects of the present invention, a program storage device, readable by a machine, tangibly embodying a program of instructions executable by the machine to perform the above-noted methods can be provided.

According to the medium access method of the present invention, by classifying stations in the CSMA/CA based wireless LAN system into a number of groups according to a transmission priority and assigning different DIFSs to each of the classified groups, a transmission opportunity can be guaranteed to the station that belongs to the higher priority group.

Moreover, by fixedly assigning different back-off times even to the same priority group of stations according to the transmission priority, and making it possible to be reset by the back-off time which is assigned to each station whenever re-transmission contention occurs, a transmission opportunity can be guaranteed to the station with the higher transmission priority in the same priority group.

As such, the transmission opportunity of the higher priority station can be guaranteed irrespective of the number of stations that wish to make a transmission in the CSMA/CA based wireless LAN system, and throughput degradation can be prevented due to a reduced chance of a collision since each station has a different waiting time (DIFS+back-off time).

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a diagram of a DCF access control method defined as a basic specification in the IEEE 802.11 standard.

FIG. 2 is a timing chart of a back-off procedure of a number of stations for medium access.

FIG. 3 is a graph of an exponential increase of contention windows by collisions.

FIG. 4 is a table of an example of a priority according to the Deng algorithm.

FIG. 5 is a conceptual diagram of how DIFS and back-off time are assigned to each group of stations according to an embodiment of the present invention

FIG. 6 is a graph of the details of the assignment of the DIFS and the back-off time by each group according to an embodiment of the present invention.

FIG. 7 is a flowchart of a back-off procedure of each station according to an embodiment of the present invention.

FIG. 8 is a timing chart of how a number of stations occupy a medium in accordance with a medium access method of an embodiment of the present invention.

### DETAILED DESCRIPTION OF THE INVENTION

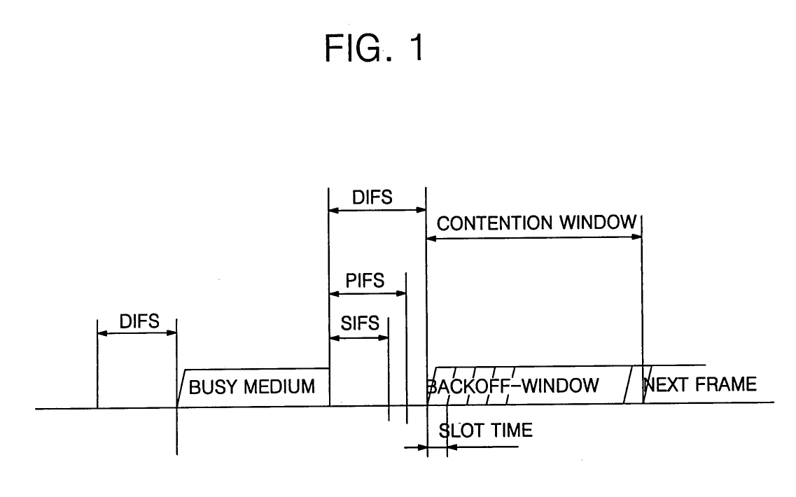

FIG. 1 is a diagram of a DCF access control method defined in the IEEE 802.11 standard.

As shown in FIG. 1, the DCF access control method defined in the IEEE 802.11 standard makes use of a contention-based algorithm known as CSMA/CA.

In the CSMA/CA based wireless LAN system, a station checks whether a medium is busy. If so, the station waits for a predetermined time, and then, if the medium is idle, reduces a back-off time. As such, the predetermined time that each station waits to initiate traffic is called an IFS (InterFrame Space). As shown in FIG. 1, in general, there are three IFSs in the MAC protocol traffic. DIFS refers to a DCF interframe space, PIFS refers to a PCF interframe space, and SIFS refers to a short interframe space.

An example of a station using the DCF access control method to send a frame is described as follows.

The station using the DCF access control method checks whether the medium is busy before sending the frame. When the medium is idle for a time longer than or equal to the DIFS (DCF Interframe Space), the frame can be sent.

On the contrary, when the medium is busy, the station initiates a back-off procedure. Then, the station occupies the medium to send the frame only when a value of a back-off timer is equal to zero (0).

In the back-off procedure, a random back-off time is assigned to the back-off timer. The back-off time has the following relational formula:
Back-off Time=random( ) * slot time
where, random( )=a random integer having a uniform probability distribution in [0, CW], and
CW=Contention Window, Cwmin [symbol] CW [symbol] Cwmax.

The back-off timer is reduced as much as the slot time whenever the medium maintains an idle state during the slot time, but is no longer reduced when the medium is changed into a busy state at any moment.

After the medium becomes idle during the DIFS, the back-off timer can be reduced as much as the slot time again. Here, the back-off time is set with a randomly selected value within the set back-off time rather than a preset value.

Moreover, the back-off time set to an arbitrary station is reduced as much as a time slot while the medium is idle. Further, when the station must perform a retransmission contention due to a failure in transmission contention, the back-off time is reduced as much as the time slot beginning with the value reduced in the previous transmission contention. Thus, the station cannot initiate transmission until the value of the back-off timer is equal to zero (0).

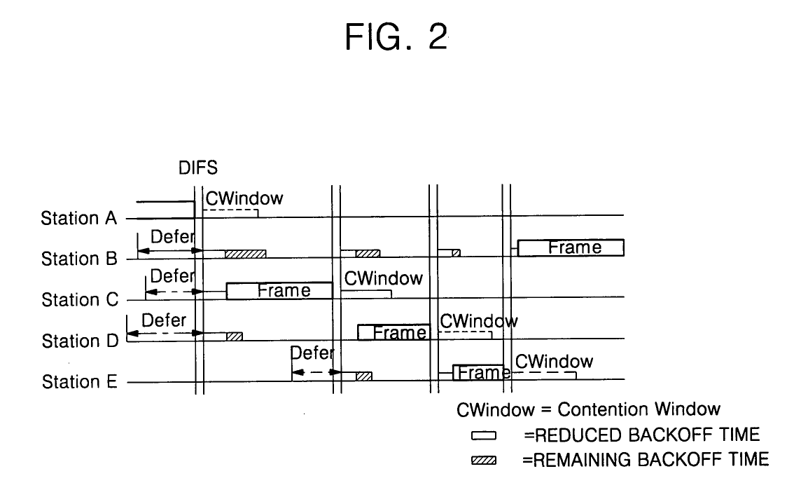

FIG. 2 is a timing chart of how a number of stations perform a back-off procedure in order to have access to a media by means of a conventional medium access method.

Referring to FIG. 2, since a station A has already transmitted a frame, other stations are on standby until the frame transmission of station A has been completed, and wait more for the DIFS. Nevertheless, when the medium is still idle, other stations each reduce their respective back-off times. While a station B and a station D each reduce their back-off time, the back-off time of a station C has already become equal to zero (0). Thus, the station C occupies the medium to transmit the frame. Because the medium is idle after the station C transmits the frame, stations B, D and E make a transmission contention. After waiting for the DIFS, each of the stations B, D and E starts to reduce its back-off time. Here, because the back-off time of the station D is reduced earliest, the station D occupies the medium. After the station D transmits the frame, the medium becomes idle. Thus, the stations B and E make a transmission contention. After waiting for the DIFS, each of the stations B and E starts to reduce its back-off time. Because the back-off time of station E is reduced earliest, the station E occupies the medium to transmit the frame. And then, station B also reduces the remaining back-off time after waiting for the DIFS. When the back-off time becomes equal to zero (0), station B occupies the medium to transmit the frame.

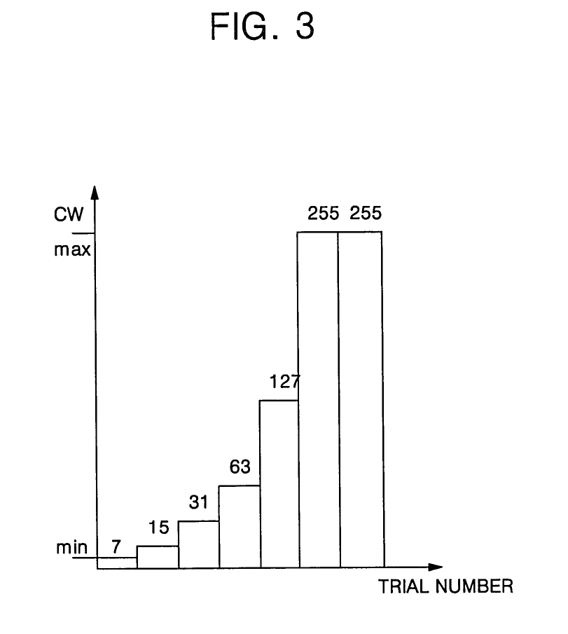

When a number of stations attempt to make a transmission at the same time, a collision occurs. Whenever such a collision occurs, a CW (Contention Window) increases in an exponential manner as shown in FIG. 3. Moreover, the back-off timer has a new back-off time.

After a succeeding transmission, the CW returns to CWmin (minimum CW). This exponential increase of the CW lowers the re-collision probability, thereby increasing network stability.

Although the DCF access control method of IEEE 802.11 is a medium access control method capable of offering all stations a fair opportunity to have access to media, it is not useful in establishing a wireless LAN system that supports QoS.

The access control method devised to guarantee QoS in the wireless LAN has a contention-free method and a contention-based method. A polling based method is a representative contention-free media access method, which is used by PCF.

The PCF, as a centralized access control algorithm by the polling method, requires an apparatus called a PC (Point Coordinator). The PC gives a transmission opportunity to a particular station by transmitting a frame called a CF-poll. When the PCF is used, only the station receiving the poll alternately repeats between CFP having a transmission opportunity without contention and CP capable of accessing the medium by contention.

In order to use the PCF, the PC assumes a function of a scheduler. This is because the PC must predict information on the transmission time and the frame size of all stations to which real-time data are to be transmitted, and perform appropriate scheduling at each cycle to give the transmission opportunity to the stations. When the appropriate scheduling is not preformed, some stations may have an access delay that is greater than a limited time, thereby lowering a transmission efficiency of the medium.

One method for offering a priority to each station when the stations contend for transmission in the contention-based wireless LAN system is to apply different CWs that determine the DIFS and back-off time according to the priority when the CSMA/CA algorithm is used.

As the DIFS and CW become smaller, each data traffic or station has a higher priority.

With this method, a ‘Deng algorithm’ and an EDCF (Enhanced Distributed Coordination Function) of IEEE 802.11e classify data traffic or stations into several groups according to a priority, and then provide a different priority to each group.

The Deng algorithm assigns different DIFSs and CWs according to the priority.

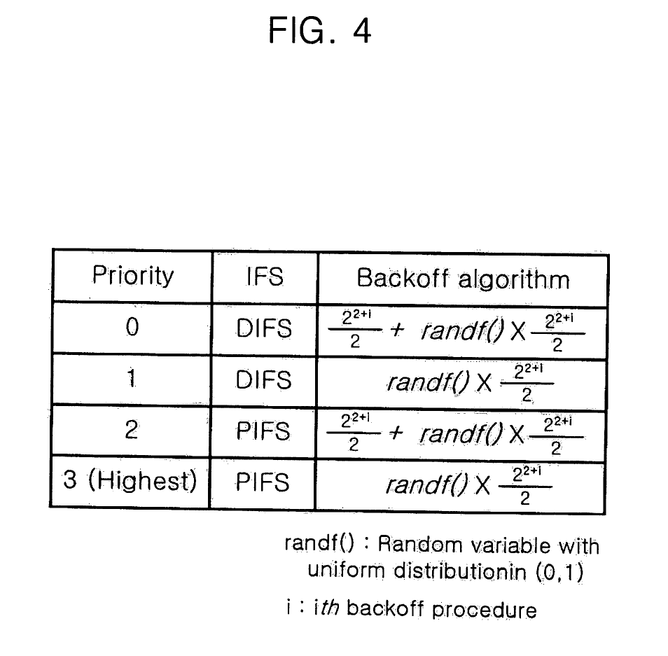

FIG. 4 shows an example where stations are classified into four priority groups by a combination of two different DIFSs and two different CWs using the Deng algorithm. Here, a priority of 3 is the highest priority.

Although the EDCF also provides a priority according to the same principle as the Deng algorithm, the EDCF has an additional feature in that data is classified into several traffic categories and then a priority is given to each traffic category. Therefore, when any one station has several traffic categories, the station is subjected to transmission contention between different traffic.

As compared with the polling method, the contention-based algorithm such as CSMA/CA has various advantages as follows.

First, since a media access rule is distributed, there is no pre-condition regarding whether a station serving as a base station exists, and an overloaded task such as scheduling is not given to an AP.

Second, transmission can be made within a limited access time by sharing the medium among stations having different priorities and by giving a priority to the higher priority station in using the medium.

Third, in the case where no transmission is carried out by the higher priority station, the lower priority station can occupy the medium to selectively use a lot of bandwidth, so that the medium usage can be increased.

For the wireless LAN system using the Deng algorithm and EDCF, the higher priority station does not always win in transmission contention whenever contending with the lower priority station, but just has a higher probability to win in transmission contention to have a transmission chance.

In other words, when different priority stations contend with each other, the transmission sequence is not definitely determined based on the priority. Sometimes, the lower priority station can win in the contention.

This is because conventionally when an arbitrary back-off time is set to an arbitrary station, the operating back-offtime is set as a randomly selected value within the set back-off time. Moreover, in an idle state, the back-off time set to an arbitrary station is reduced as much as a time slot. Thus, when the station must perform a retransmission contention due to a failure in transmission contention, the back-off time is reduced as much as the time slot beginning with the value reduced in the previous contention. That is, when several transmission contentions are performed, the remaining back-off time is substantially shortened.

This may give an opportunity to the lower priority station. However, in the other sense, this results in depriving the higher priority station of a transmission opportunity when transmission is needed.

Moreover, as the number of stations increase, the number of collisions between stations increases. Further, when deprived of the transmission opportunity, a station contends with other stations having a reduced back-off time. If this situation occurs frequently, each station belonging to a higher priority group experiences an increase in the transmission delay. Eventually, this leads to deterioration of the QoS.

An increase in the transmission delay of the high priority stations also appears in the transmission contention among stations that belong to the highest priority group. When only the highest priority stations are in transmission contention, each station will have the same priority, whose contention environment is the same as the DCF of IEEE 802.11

In other words, the priority of each station is meaningless, and the transmission opportunity is given only by the fair contention. As the number of higher priority stations increases, the throughput of an entire system is lowered due to the collisions among stations, and the transmission delay which each station experiences is lengthened. In the worst case, it may be impossible for any station to complete a transmission within the limited connection time. Particularly, in the case of the service requiring a real time characteristic, such as voice traffic, the effect is far greater and the normal voice service cannot be provided.

The present invention will now be described more fully hereinafter with reference to the accompanying drawings, in which exemplary embodiments of the present invention are shown. This invention may, however, be embodied in different forms and should not be construed as limited to the embodiments set forth herein. Rather, these embodiments are provided so that this disclosure will be thorough and complete, and will fully convey the details of the invention to those skilled in the art. In the drawings, the thickness of layers and regions are exaggerated for clarity. Like numbers refer to like elements throughout the specification.

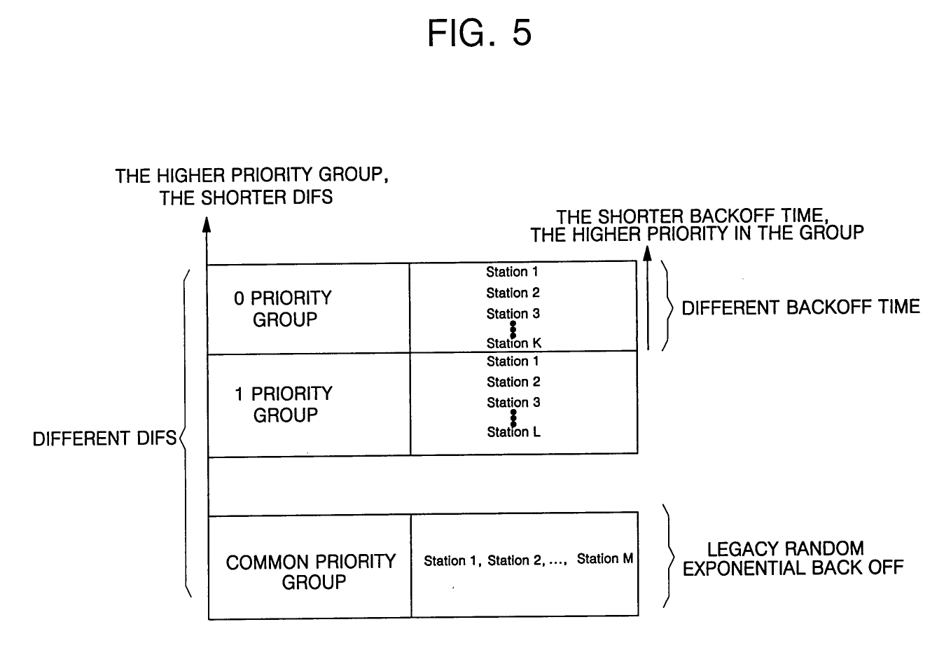

FIG. 5 is a conceptual diagram of how the DIFS and back-off time are assigned to each group of stations according to an embodiment of the present invention.

Referring to FIG. 5, in order to assign the DIFS and back-off time to each group of registered stations in the same LAN, the present invention defines a plurality of groups to which a priority is given. For example, as shown in FIG. 5, the plurality of groups can be classified into a zero (0) priority group, a first priority group, . . . , and a common priority group.

DIFSs that are different from each other are respectively assigned to defined groups according to their priority. Therefore, the same DIFS is assigned to the same group of stations. The higher the priority of the group, the smaller the DIFS assigned to the group.

Additionally, even in the same group, the back-off times are different. Thus, a plurality of back-off times are assigned to the group. In other words, the maximum back-off time is assigned to an arbitrary group, and a plurality of back-off times are defined with a difference in a range of the maximum back-off time.

The lowest priority group of the stations can use the exponential random back-off algorithm of IEEE 802.11.

Since any station in the same group must not only have a different back-off time than the other stations but also determines the priority in the group, it is reasonable for the back-off time of each station to be provided either by a determination according to mutual consent among the same group of stations or by an object that governs a network.

Furthermore, when the priority group to which an arbitrary station belongs is changed or when the priority in the group is changed, it is necessary to reset the DIFS and the back-off time.

An AP takes charge of the operation and management of a BSS (Basic Service Set). In the BSS, the AP can perform functions, such as management, distribution and change of information on the DIFS and the back-off time of each station, which wishes to get a service. To this end, the AP can use a management frame.

The AP manages a database on which information on the priority and back-off time of the stations, which belong to each group as well as the priority group, is recorded, and updates the database if the information is changed.

Therefore, although not shown, the AP according to the present invention generally comprises a memory for storing a program and a processor connected to the memory for executing the program.

The processor of the AP performs the steps of defining a plurality of groups to which a priority is given, and assigning different DIFSs and maximum back-off times to each group according to the priority such that a sum of the DIFS and the maximum back-off time of a group to which an arbitrary priority is given is smaller than the DIFS of the next lower priority group; organizing stations connected to the wireless LAN into the defined group according to a transmission priority; assigning different and fixed back-off times to each station organized into an arbitrary group in a range below a value of the maximum back-off time set to the group according to the transmission priority among the stations organized into the group; and transmitting the assigned DIFS and back-off time to each station in order for each station to perform the CSMA/CA based medium access by the DIFS assigned to the group into which it is organized and the back-off time assigned to itself in the group.

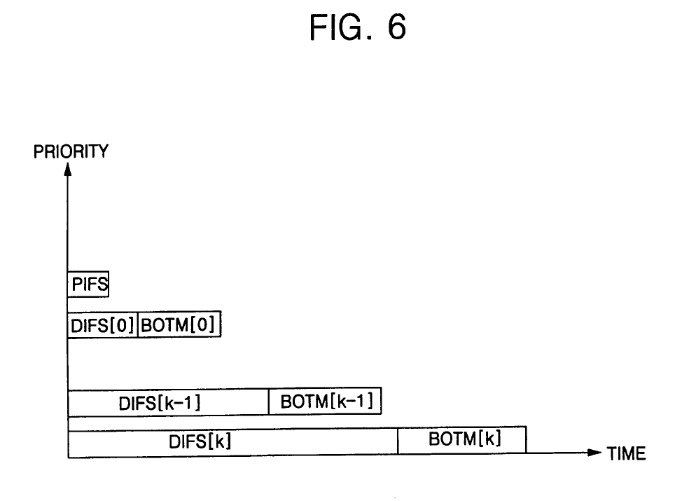

FIG. 6 is a graph of the details of the assignments of the DIFS and the maximum back-off time by each group according to an embodiment of the present invention.

Referring to FIG. 6, it can be seen that the (Point Coordination Function InterFace Space) has a timing relationship with the DIFSs of each priority group. In FIG. 6, a horizontal axis represents time, while a vertical axis represents the group priority. The more it goes up, the higher priority group it is. As illustrated, the DIFS of a group to which an arbitrary priority is given is set longer than the sum of the DIFS and the back-off time of the group with the next higher priority.

In other words, different DIFS and maximum back-off time are assigned to each group such that the sum of the DIFS and the maximum back-off time of a group to which the arbitrary priority is given is smaller than the DIFS of the next lower priority group according to the priority.

For example, DIFS[k−1] represents the DIFS of the station whose priority belongs to the kth highest group, and BOTM[k−1] represents the back-off time of the station whose priority can belong to the kth highest group.

Therefore, the maximum time for which the station belonging to the kth highest group waits in the transmission contention is DIFS[k−1] +BOTM[k−1], and the DIFS by each group is determined as follows:
DIFS[0]>PIFS (1)
DIFS[k]>DIFS[k−1]+BOTM[k−1] (2)
where, k is greater than or equal to 1.

As shown in above relations, DIFS[0] which is the DIFS of the highest priority group is set to be greater than PIFS.

When attempting to perform transmission, all stations, at least, must check whether a medium is empty for a time of the DIFS. Thus, when different priority groups of stations contend with each other, a higher priority group of stations always win in the transmission contention.

Additionally, since the station belonging to the higher priority group transmits the frame before the station belonging to the lower priority group checks whether the medium is idle during the DIFS, the collision does not occur.

Moreover, even in the same priority group, the back-off time set according to the priority is different. That is, within the maximum back-off time assigned to an arbitrary group, the higher priority the station is, the shorter back-off time it has.

As described above, the AP sets the DIFS to each group, assigns the back-off time set in the arbitrary group, and then organizes the stations connected to the wireless LAN into the group defined according to the transmission priority.

Next, different back-off times are assigned to each station organized into the arbitrary group within a range of a value of the maximum back-off time assigned to the group according to the transmission priority among the stations organized into the group.

The back-off time assigned to each station is a fixed value for each station, where “fixed” means that the back-off time set into an arbitrary station is fixed to the set back-off time.

In other words, by fixing the back-off time assigned to each station, when an arbitrary back-off time is assigned to the arbitrary station, the station is assigned to the assigned back-off time. Moreover, the back-off time assigned to the arbitrary station is rather reset to the back-off time that is first assigned, thus reduced as much as a time slot in every transmission contention, than reduced from the reduced state during the previous transmission contention.

The AP organizes each station into the groups to set the DIFS and the back-off time. Then, in order to allow each station to perform the CSMA/CA based medium access by means of a value of the DIFS assigned to the group into which each group is organized as well as a value of the back-off time assigned to each station belonging to the group, the AP transmits the assigned values of the DIFS and the back-off time to each station.

A characteristic of the back-off time according to an embodiment of the present invention will now be described in more detail.

First, the back-off time used in every transmission contention by each station belonging to each priority group is determined by the AP, which is fixed unless the priority is changed. It is referred to as Back-off_time[Station ID][Group ID], where Group ID represents an identifier of the priority group to which the arbitrary station belongs, and Station ID represents an identifier of the arbitrary station belonging to the Group ID.

Additionally, the stations belonging to an arbitrary priority group have a unique back-off time in the group to which they belong. That is, different stations in the same group do not share the same back-off time:
Back-off_time[Station ID1][Group ID]≠Back-off_time[Station ID2][Group ID] (3)
where [Station ID1]≠[Station ID2].

The magnitude of the back-off time of the arbitrary station is less than or equal to the BOTM (Maximum Back-off Time) of the priority group to which the station belongs.

Moreover, the back-off timers of all stations return to Back-off_time[Station ID][Group ID] after the medium maintains the idle state for the time of DIFS subsequent to the busy state.

Accordingly, the back-offtime of all stations returns to Back-off_time[Station ID][Group ID] when re-transmission contention is performed after the collisions between the stations.

In addition, the determination and operation of the back-off time of the stations belonging to the lowest priority group can follow ‘Random Exponential Back-off algorithm’ provided by IEEE 802.11.

According to this back-off procedure, all stations have a unique back-off time in the group to which they belong, and the time value is fixed during contention. Additionally, even while the back-off timer is reduced in the idle state of the medium, when the medium is changed into the busy state, the back-off timer must return to the initial back-off time. For this reason, the higher priority station can have a definite transmission opportunity in transmission contention among stations belonging to the same group.

The lowest priority group of stations has substantially no priority to other stations. Therefore, it does not matter that the stations belonging to this group uses ‘Random Exponential Back off algorithm’ defined in IEEE 802.11, for easy operation of the network.

A specific method for determining the back-off time to be used by each station in the AP and an exemplary embodiment for determining the maximum back-off time (BOTM) of each priority group will be described.

However, the method for determining the back-off time devised in the present invention and the method for determining the BOTM of each priority group are not limited in the following.

The determination of the maximum back-off time of the kth highest priority group follows the following relation:
(BOTM[k−1])=(N−1) * slot time (4)
where, N is total number of stations belonging to the kth highest priority group and k is larger than or equal to 1.

The back-off time of station belonging to the Mth highest priority station in the arbitrary group follows the following relation:
Back-off_Time[M−1]=(M−1) * slot time (5)
where, M is greater than or equal to 1.

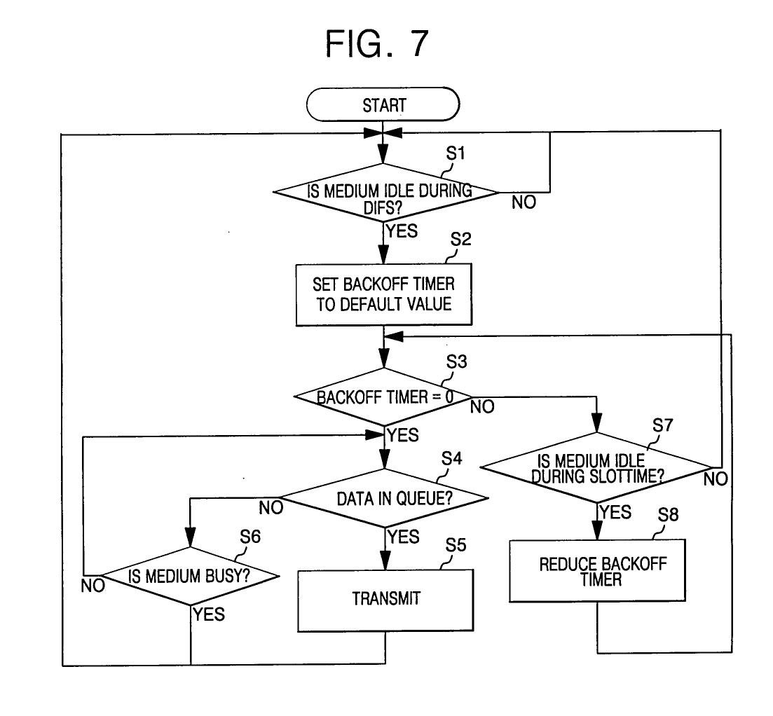

FIG. 7 illustrates the back-off procedure performed by each station that wishes to occupy the medium for data transmission in the BSS system in which the assignment of the DIFS and the back-off time are applied to each group according to the present invention.

Referring to FIG. 7, before occupying the medium, the station that wishes to transmit arbitrary data should monitor whether the medium is idle. Therefore, the station determines whether the medium is idle during its DIFS (S1). As the determined result, if so, the back-off timer of the station is set by a default value assigned to itself in an initial setting (S2). Next, the station determines whether the back-off timer is equal to zero (0). If so, since the station can occupy the medium to transmit the data, it determines whether there is data in a queue (S4). If there is data in the queue, the station transmits the data through the medium. Otherwise, if there is not data in the queue, the station determines whether the medium is busy (S6), and if so, it again performs the step of determining whether the medium is idle during its DIFS. Otherwise, when the medium is not busy, it proceeds to the step for determining whether there is data in the queue (S4).

Meanwhile, in the step (S3) for determining whether the value of back-off timer is equal to zero (0), when the value of back-off timer is not equal to zero (0), the station determines whether the medium is idle during one slot time (S7). When the medium remains in the idle state during one slot time, the station reduces the back-off timer as much as one slot time (S8), and proceeds back to step (S3) for determining whether the value of the back-off timer is equal to zero (0), and thus keeps reducing the back-off timer as much as slot time while the medium is idle.

As illustrated above, the back-off procedure according to an embodiment of the present invention is characterized in that the back-offtimer necessarily returns to Back-off_time[STA ID] after the busy state of the medium. Therefore, even though the back-off time is being decreased before the busy state of the medium, or the back-off time is equal to zero (0) with no data in the queue before the busy state of the medium, the station has no advantage when re-contention occurs.

The transmission opportunity is given only by the priority of station that takes part in the contention. This prevents a situation in which the higher priority station delays its transmission due to the lower priority station in the contention among the stations that belong to the same group.

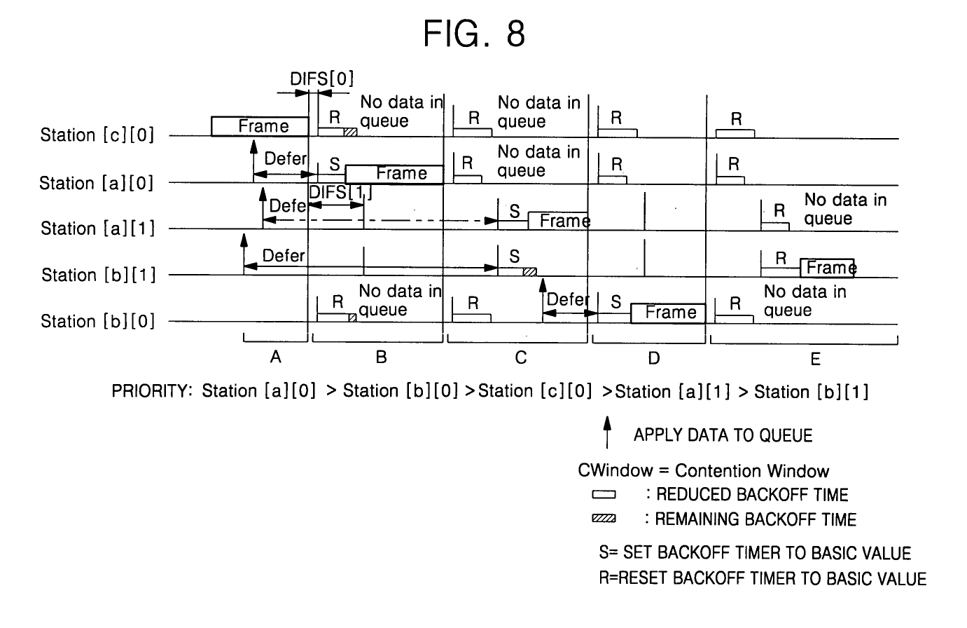

FIG. 8 is a timing chart of how a number of stations occupy the medium by the medium access method according to an embodiment of the present invention.

First, the transmission priority of each station is as follows. As to the meaning of station[a][0] in FIG. 8, ‘0’ represents the priority of the group to which the station belongs, and makes it possible to get information on the DIFS, and ‘a’ represent the priority which the station is assigned in that group, and makes it possible to get information on the back-off time. The smaller the numeral becomes and the earlier the alphabetical order becomes, the higher priority the station has with the smaller value.

Therefore, the priority for occupying the medium according to the priority of each station is as follows: station[a][0] >station[b][0] >station[c][0] >station[a][1] >station[b][1].

Occupying the medium by each station based on this priority according to an embodiment of the present invention is described as follows.

In time interval A, the medium maintains the busy state and occupied by Station[c][0], and the station that wishes to transmit a frame at this time starts the back-off procedure. When the medium transits from the busy state to the idle state (time interval B), the contention starts among a number of stations that wish to make a transmission, and each station cannot transmit the frame before determining whether the medium is idle during the DIFS plus back-off time of each station.

Therefore, Station[a][0] that has the highest priority among the stations that takes part in the transmission contention transmits the frame, and since the DIFS+back-off time of each station is different, there is no collision in transmission.

In fact, the time interval B is provided for contention between the stations that belong to different priority groups, so that two stations having the relatively lower priority do not even check whether the medium is idle for a time of DIFS[1]. Even when there is no data in the queue after transmission, Station[a][0] resets the back-off timer and keeps performing the back-off procedure. However, before the data is inputted to the queue, Station[a][0] does not directly take part in the contention.

In time interval C, Station[a][1] and Station[b][1] take part in the contention. Since the contention is made between stations belonging to the same group, two stations must wait for DIFS[1] and wait again for their own back-off time. Therefore, Station[a][1] whose back-off time is smaller, that is, whose priority is higher in the same group, has the transmission opportunity. However, although Station[b][0] has higher priority than Station[a][1] and Station[b][1], since the medium is already occupied by Station[a][1] and thus ready to transmit the frame, it can get the transmission opportunity after deferring the transmission and waiting for its back-off time (time interval D).

In time interval E, Station[b][1] is a unique contention participant, and although the back-off time is reduced in time interval C, the back-off timer is reset in time interval E according to the back-off procedure.

As can be seen from the foregoing, the possibility to occupy a medium is not determined according to which station has access to the medium first, but which station has a higher transmission priority. To be more specific, although giving access to the medium later than the station having a lower transmission priority, the station having the higher transmission priority occupies the medium earlier than the station having the lower transmission priority.

A variety of substitutions and modifications can be made to the present invention by those of skilled in the art without departing from the basic concepts thereof, so that the present invention is not limited to the aforementioned embodiment and the accompanying drawings.

1. A method comprising:
defining a plurality of groups to which a priority has been given, and assigning different DIFSs (Distributed Coordination Function InterFrame Spaces) and maximum back-off times to each group according to the given priority such that a sum of the DIFS and the maximum back-off time of a group to which an arbitrary priority has been given is smaller than a sum of the DIFS and the maximum back-off time of a group having a next lower priority;
organizing stations connected to the wireless LAN (Local Area Network) into defined groups according to a transmission priority;
assigning different fixed back-off times to each station organized into an arbitrary group below a range of the maximum back-off time assigned to a relevant group according to the transmission priority among the stations organized into the relevant group such that the sum of the DIFS and the maximum back-off time of the group to which the arbitrary priority has been given is smaller than the sum of the DIFS and the maximum back-off time of the group having the next lower priority; and
transmitting the assigned DIFS and back-off time to each station in order for each station to reset its back-off timer to the fixed back-off time in every transmission contention by the DIFS assigned to the group into which each station is organized and the back-off time assigned to the stations in the group, and to perform a medium access based on a CSMA/CA (Carrier Sense Multiple Access with Collision Avoidance).

2. The method of claim 1, wherein the different DIFSs and maximum back-off times are assigned such that the sum of the DIFS and the maximum back-off time of the group to which the arbitrary priority has been given is smaller than the DIFS of the group having the next lower priority.

3. The method of claim 1, wherein the assigned DIFS and back-off time are transmitted to each wireless LAN station via a management frame.

4. The method of claim 1, wherein, during the assigning of different DIFSs and maximum back-off times to each group, assignments of the back-off times of stations that belong to the group having the lowest priority are in accordance with a ‘Random Exponential Back-off Algorithm’ defined by IEEE (Institute of Electrical and Electronic Engineers) Standard 802.11.

5. The method of claim 1, wherein the DIFS of a station having the highest priority is larger than a PIFS (Point Coordination Function InterFace Space).

6. The method of claim 1, wherein the back-off time of an arbitrary station is an integer multiple of a slot time.

7. A method comprising:
requesting a register of an AP (Access Point) in a wireless LAN (Local Area Network), the AP classifying each station of a plurality of stations into a plurality of priority groups according to a transmission priority to assign different DIFSs (Distributed Coordination Function InterFrame Spaces) to each priority group, and the AP assigning different fixed back-off times according to the transmission priority in the same group and setting the DIFS and the back-off time of each station such that a sum of the DIFS and the back-off time has a fixed difference according to the transmission priority of each station;
receiving and storing the DIFS and the back-off time set into each station from the AP;
attempting to make a contention for medium access by priority with the DIFS and the back-off time set into each station when access to the medium is required for a data transmission; and
resetting a station's back-off time to the fixed back-off time to attempt to make a re-contention for medium access when the station fails in the contention for medium access.

8. The method of claim 7, wherein the different DIFSs and maximum back-off times are assigned to each group according to priority such that the sum of the DIFS and the maximum back-off time of a group to which an arbitrary priority has been given is smaller than the DIFS of the group having the next lower priority.

9. A method comprising:
defining a plurality of groups to which a priority is given at an AP(Access Point), and assigning different DIFSs (Distributed Coordination Function InterFrame Spaces) and maximum back-off times to each group according to priority such that a sum of the DIFS and the maximum back-off time of a group to which an arbitrary priority has been given is smaller than the DIFS of the group having the next lower priority;
organizing stations connected to a wireless LAN (Local Area Network) into defined groups according to a transmission priority at the AP;
assigning at the AP different and fixed back-off times to each station organized into an arbitrary group below a range of the maximum back-off time assigned to the relevant group 1I according to the transmission priority among stations organized into the relevant group;
attempting to make a contention for medium access by priority with the DIFS and the back-off time set into the station when access to the medium is required for a data transmission; and
resetting a station's back-off time to the fixed back-off time and attempting to make a re-contention for medium access when the station fails in the contention for medium access.

10. The method of claim 9, wherein, during the assigning of different DIFSs and maximum back-off times to each group, assignments of the back-off times of stations that belong to the group having the lowest priority are in accordance with a ‘Random Exponential Back-off Algorithm’ defined by IEEE (Institute of Electrical and Electronic Engineers) Standard 802.11.

11. An AP (Access Point) in a (Carrier Sense Multiple Access with Collision Avoidance) based wireless LAN (Local Area Network), comprising:
a memory for storing a program; and
a processor connected to the memory and adapted to execute the program, wherein, in accordance with the program, the processor:
defines a plurality of groups to which a priority is given, and assigns different DIFSs (Distributed Coordination Function InterFrame Spaces) and maximum back-off times to each group according to priority such that a sum of the DIFS and the maximum back-off time of a group to which an arbitrary priority has been given is smaller than the DIFS of the group having the next lower priority;
organizes stations connected to the wireless LAN (Local Area Network) into defined groups according to a transmission priority;
assigns different and fixed back-offtimes to each station organized into an arbitrary group below a range of the maximum back-offtime assigned to the group according to the transmission priority; and
transmits the assigned DIFS and back-off time to each station in order for each station to perform the CSMA/CA based medium access by the DIFS assigned to the group into which the station is organized and the back-off time assigned to the station in the group.

12. A wireless LAN (Local Area Network) station in a CSMA/CA (Carrier Sense Multiple Access with Collision Avoidance) based wireless LAN, comprising:
a memory for storing a program; and
a processor connected to the memory and adapted to execute the program, wherein, in accordance with the program, the processor:
requests a register of an AP (Access Point) in the wireless LAN, the AP classifying each station into a plurality of priority groups according to a transmission priority to assign different DIFSs (Distributed Coordination Function InterFrame Spaces) to each priority group, and the AP assigning a different fixed back-off time according to the transmission priority in the same group and setting the DIFS and the back-off time of each station such that a sum of the DIFS and the back-off time has a fixed difference according to the transmission priority of each station;
receives and stores the DIFS and the back-off time set into the station from the AP;
attempts to make a contention for medium access by priority with the DIFS and the back-off time set into the station when the station requires access to the medium for a data transmission; and
resets the station's back-off time to the fixed back-off time to attempt to make a re-contention for medium access when the station fails in the contention for the medium access.

13. A program storage device, readable by a machine, tangibly embodying a program of instructions executable by the machine to perform a method comprising:
defining a plurality of groups to which a priority has been given, and assigning different DIFSs (Distributed Coordination Function InterFrame Spaces) and maximum back-off times to each group according to the given priority such that a sum of the DIFS and the maximum back-off time of a group to which an arbitrary priority has been given is smaller than a sum of the DIFS and the maximum back-off time of a group having a next lower priority;
organizing stations connected to the wireless LAN (Local Area Network) into defined groups according to a transmission priority;
assigning different fixed back-off times to each station organized into an arbitrary group below a range of the maximum back-off time assigned to a relevant group according to the transmission priority among the stations organized into the relevant group such that the sum of the DIFS and the maximum back-off time of the group to which the arbitrary priority has been given is smaller than the sum of the DIFS and the maximum back-off time of the group having the next lower priority; and
transmitting the assigned DIFS and back-off time to each station in order for each station to reset its back-off timer to the fixed back-off time in every transmission contention by the DIFS assigned to the group into which each station is organized and the back-off time assigned to the stations in the group, and to perform a medium access based on a CSMA/CA (Carrier Sense Multiple Access with Collision Avoidance).

14. A program storage device, readable by a machine, tangibly embodying a program of instructions executable by the machine to perform a method comprising:
requesting a register of an AP (Access Point) in a wireless LAN (Local Area Network), the AP classifying each station of a plurality of stations into a plurality of priority groups according to a transmission priority to assign different DIFSs (Distributed Coordination Function InterFrame Spaces) to each priority group, and the AP assigning different fixed back-off times according to the transmission priority in the same group and setting the DIFS and the back-off time of each station such that a sum of the DIFS and the back-off time has a fixed difference according to the transmission priority of each station;
receiving and storing the DIFS and the back-off time set into each station from the AP;
attempting to make a contention for medium access by priority with the DIFS and the back-off time set into each station when access to the medium is required for a data transmission; and
resetting a station's back-off time to the fixed back-off time to attempt to make a re-contention for medium access when the station fails in the contention for medium access.

15. A program storage device, readable by a machine, tangibly embodying a program of instructions executable by the machine to perform a method comprising:
defining a plurality of groups to which a priority is given at an AP(Access Point), and assigning different DIFSs (Distributed Coordination Function InterFrame Spaces) and maximum back-off times to each group according to priority such that a sum of the DIFS and the maximum back-off time of a group to which an arbitrary priority has been given is smaller than the DIFS of the group having the next lower priority;
organizing stations connected to a wireless LAN (Local Area Network) into defined groups according to a transmission priority at the AP;
assigning at the AP different and fixed back-off times to each station organized into an arbitrary group below a range of the maximum back-off time assigned to the relevant group according to the transmission priority among stations organized into the relevant group;
attempting to make a contention for medium access by priority with the DIFS and the back-off time set into the station when access to the medium is required for a data transmission; and
resetting a station's back-off time to the fixed back-off time and attempting to make a re-contention for medium access when the station fails in the contention for medium access.
